(19) United States
(12) Patent Application Publication
(10) Pub. No.: US 2009/0182739 A1
(43) Pub. Date: Jul. 16, 2009

(54) USING METADATA TO ROUTE DOCUMENTS

(75) Inventors: Sterling J. Crockett, Bothell, WA (US); Adam Harmetz, Kirkland, WA (US); John D. Fan, Duvall, WA (US); Adrian Fanaru, Sammamish, WA (US); Dustin Friesenhahn, Seattle, WA (US); Sushanta Sengupta, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/972,552

(22) Filed: Jan. 10, 2008

(51) Int. Cl. G06F 7/10; G06F 17/30; G06F 3/048

(52) U.S. Cl. 707/6; 715/764; 707/E17.014

(57) ABSTRACT

Document metadata is evaluated against rules to determine what action to perform on the document. The actions include routing the document to a specific location, returning a location of where the document is stored, executing custom code that is associated with the document and routing the document to another routing engine that applies a set of routing rules against the document.

### BACKGROUND

Many organizations store documents in very large document repositories. One way to separate the documents that are stored within the repository is to manually separate them by various document properties. For example, documents may be placed into different folders based on the year they were created, who authored them, what department created them, and the like. Placing the documents into different folders may help to enhance the browsing experience and/or enable zones of management for various documents (e.g. permissions on a folder, retention policies on a folder).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Document metadata is evaluated against rules to determine what action to perform on the document. Possible actions include routing the document to a specific location, returning a location of where the document is stored, returning properties relating to the destination, assigning a content type to the document, executing custom code that is associated with the document and routing the document to another routing engine that applies another set of routing rules against the document. The rules compare the metadata using various operators (e.g., =, +, −, >, <, ∈, ⊂) to determine the action(s) to perform.

### BRIEF DESCRIPTION OF THE DRAWINGS

FIG. 1 illustrates an exemplary computing device;

FIG. 2 shows a metadata routing system for automatically routing a document based on metadata

FIG. 3 illustrates a process routing a document based on metadata; and

FIG. 4 illustrates a diagram for executing a rule for document routing using metadata as described.

### DETAILED DESCRIPTION

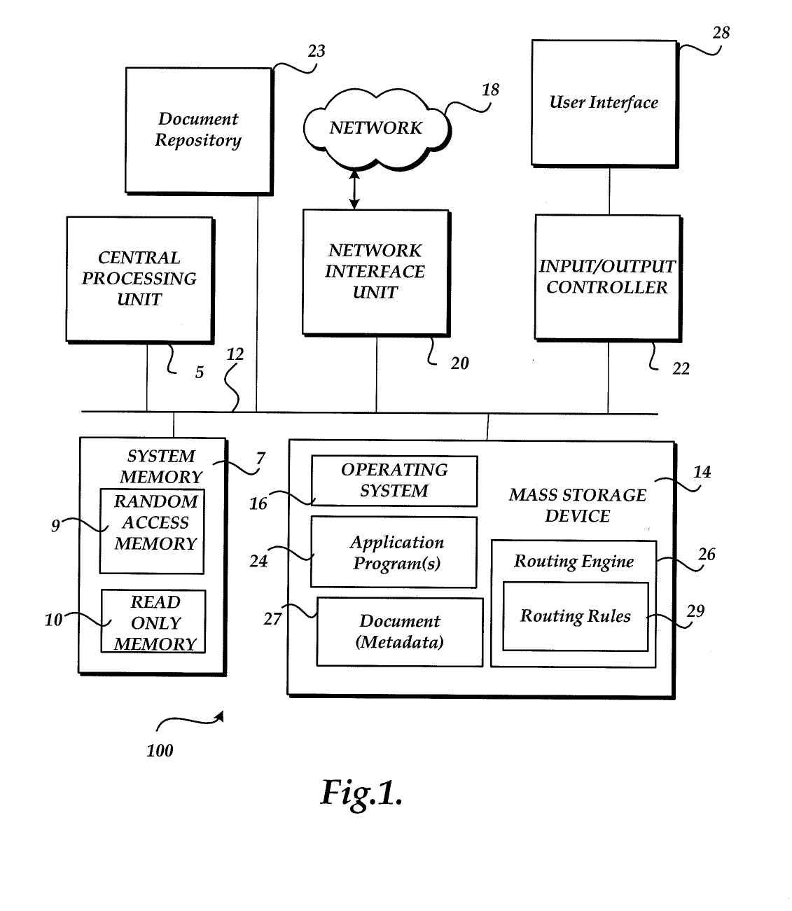

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop or mobile computer and includes a central processing unit 5 (“CPU”), a system memory 7, including a random access memory 9 (“RAM”) and a read-only memory (“ROM”) 10, and a system bus 12 that couples the memory to the CPU 5. A basic input/output system containing the basic routines that help to transfer information between elements within the computer, such as during startup, is stored in the ROM 10. The computer 100 further includes a mass storage device 14 for storing an operating system 16, application programs 24, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen that includes a user interface 28, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS VISTA® operating system from MICROSOFT CORPORATION of Redmond, Wash. The mass storage device 14 and RAM 9 may also store one or more program modules. In particular, the mass storage device 14 and the RAM 9 may store one or more application programs 24. One of the application programs may be a MICROSOFT SHAREPOINT® application.

The routing engine 26 is operative to evaluate document metadata 27 against routing rules 29 to determine what action to perform on the document. Possible actions include routing the document to a specific location, returning a location of where the document is stored, returning properties relating to the destination, assigning a content type to the document, executing custom code that is associated with the document and routing the document to another routing engine that applies another set of routing rules against the document. The routing rules 29 compare the document's metadata using various operators (e.g., =, +, −,>, <, ∈, ⊂) to determine the action to perform on document 27.

The routing rules 29 may be configured to store documents into different folders within document repository 23 according to various properties. For example, the documents may be located within document repository 23 based on the year they were created, who authored them, or some other property. Routing engine 26 is configured to evaluate routing rules 29 against a document's metadata 27 until a match is made or until all of the rules have been exhausted. One or more of the routing rules may be evaluated. According to one embodiment, some of the routing rules 29 may be marked as default rules which are executed by default by routing engine 26. Additionally, the execution order of the rules may be predefined by a user. The action performed on the document is based on the rule that matches the document's metadata. Although routing engine 26 is shown separately from application programs 24, it may be included directly within an application program 24 or at some other location. For example, the routing engine 26 may be included directly within a program, the operating system 16, at another network location, at each different web site including a document repository, and the like. The operation of routing engine 26 will be described in more detail below.

User interface (UI) 28 is designed to provide a user with a visual way to edit routing rules 29 and configuration settings for routing engine 26. For example, UI 28 may be used to display a list of the rules from which the user may select to edit. UI 28 may also be used to add or change the priority of a rule. According to one embodiment, the rules contained within routing rules 29 are applied to the document metadata one by one according to a priority until a matching rule is located. When a rule is edited, a preview may be provided that illustrates what the folder structure and/or action is performed when a document's metadata matches the rule. UI 28 may also be used to edit routing engine properties. Examples of such routing engine properties that may be edited include Enable/Disable Routing, Folder Partitioning, Name Collisions, and the like.

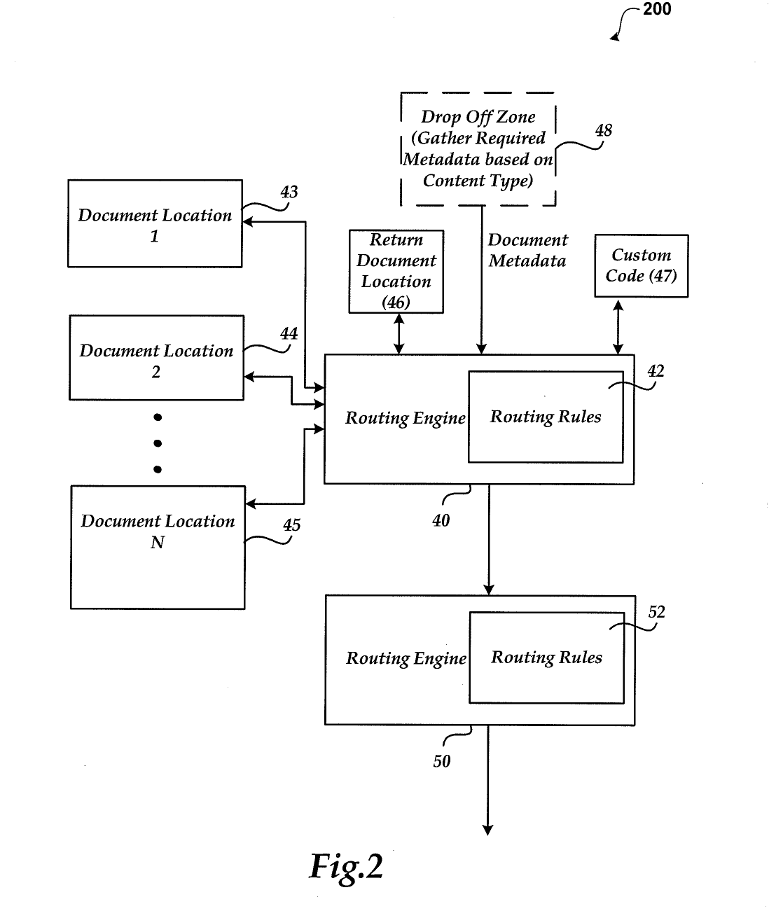

FIG. 2 shows a metadata routing system 200 for automatically routing a document based on metadata. As illustrated, routing system 200 includes routing engine 40 that includes routing rules 42, routing engine 50 that includes routing rules 52, drop off zone 48, document locations 1-N (43-45), return document location 46 and custom code 47.

Drop off zone 48 acts as an initial location to place documents before the routing rules are applied. For example, all documents may be initially placed into the drop off zone. When a document is placed in the drop off zone 48, the required metadata for that document is gathered. According to one embodiment, the metadata is gathered from a user and is based on the content type of the document. For example, one content type may require different metadata from another content type. The metadata may include many different types of data including items such as: name, author, date created, date needed, business information, and the like. According to one embodiment, documents having the same content type include some of the same metadata properties that helps to ensure consistent routing of the documents.

After the metadata for the document has been entered, the document is submitted to a routing engine (e.g. routing engine 40). Routing engine 40 access routing rules 42 and determines the routing rules to apply to the document's metadata. According to one embodiment, the routing rules to apply are selected based on the content type of the document. In this way, each document of the same content type is treated in a consistent manner. Many different types of rules may be included in routing rules 42. The routing engine 40 attempts to match one of the routing rules 42 to the metadata that is associated with the document. According to one embodiment, the routing engine 40 cycles through the rules according to a rule priority until a rule is matched or all of the rules have been attempted. According to one embodiment, when no rules match, the document is marked as not routable, and a notification is made of this fact.

The routing rules 42 are individually configurable. As such, each of the rules may be individually stored. When the routing rules are stored separately, it may be desirable to store a rule's place in the overall rule-order sequence on each individual rule. According to one embodiment, to avoid having to update multiple rules in the system any time the order is changed, the rule order is not stored as an integer, but rather as a non-integer number, which enables changing this value on a single rule to change its place in the order.

The rules may specify where a document is to be stored based on the metadata that is associated with the document. For example, each metadata type may have its own associated operators. For example, a metadata property may be compared with a specific value (e.g. “Author equals Bill”). The types of comparisons available for a given metadata type are defined as properties of the type itself.

A routing rule may also be associated with documents according to a hierarchy. For instance, when a document is assigned to a node of the hierarchy, the content can be routed again based on rules which are defined at the scope of that node. This allows for distributed management of the routing rules.

A rule may also cause the document to be routed to another routing engine, such as routing engine 52. When a document is routed to another routing engine, that routing engine applies its own routing rules to the document's metadata until a match is found. According to one embodiment, when the routing occurs within a domain boundary then a common memory may be used to store the routing rules, when the other routing engine is in another domain, then the relevant information may be stored temporarily and then sent to the other routing engine.

When the routing engine matches a rule that specifies a location for the document, then that document is stored at the determined document location (e.g. document location 43, 44 or 45). According to one embodiment, the directory structure does not need to have already been created before a document is submitted to the routing engine. In this embodiment, the routing engine is configured to automatically create a folder hierarchy. The folder hierarchy may be flat and/or have one or more levels. The rule may specify that a document location is created based on many different types of metadata values. For each value of a given property, a new folder is created, and files with this value for the property are assigned to this folder. A folder structure may be created that reflects a taxonomical structure (which may be hierarchical). Documents may be routed based on time based periods, date created, date modified, author, and the like. For example, files with a date property which falls within a specific period are assigned to a specific document location (e.g. a document folder). For example, a rule may specify that all documents created in 2007 are assigned to the “2007” folder, and all documents subject to this rule are assigned similarly to yearly folders. Documents may also be routed based on other ranges. For example, numbers can be grouped into numerical ranges, or alphanumeric strings can be grouped into ranges of that type. For example, folders are created for Authors' last names from A-M and N-Z, and files with matching properties are assigned accordingly. Many properties relating to the storing of the documents may be customized. For example, the name of the folders used to store the documents may be specified using a formula (e.g. “[Date Field]—Trip Reports” which creates folders in the format such as “12/12/07 Trip Reports). Many other customizations can be made.

The routing engine can store the file directly to the determined document location. The routing engine can also suggest where the file should be stored and provide a return document location 46 to the user. According to one embodiment a Uniform Resource Locator (URL) is provided to the user. In this scenario, the routing engine determines where a file should be stored, and report that calculated value to a client requesting this information.

Routing engines may exist at various locations within a system. For example, a routing engine may be located at each web site that includes a document repository. For example, a router may be located at each SharePoint® web site. According to one embodiment, once a routing engine is accessed, the routing rules for that routing engine are cached and stored as XML until they are no longer used.

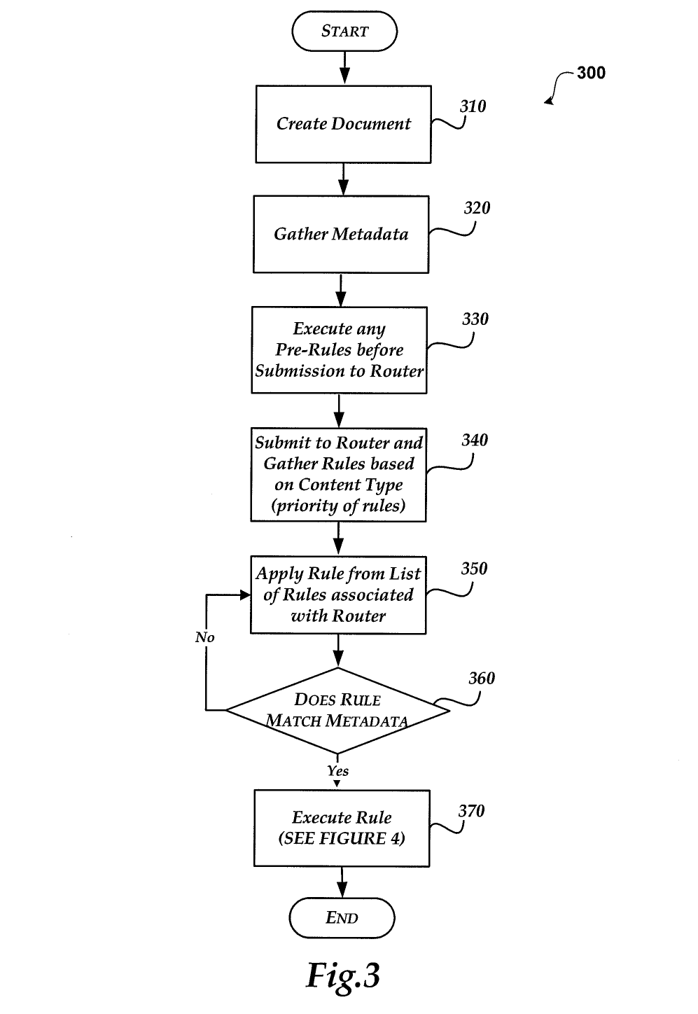

Referring now to FIG. 3, an illustrative process for routing a document based on metadata is described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 310 where a document is created. A document may be any type of document. According to one embodiment, the documents are SharePoint® documents.

Moving to operation 320, the metadata is gathered for the document. According to one embodiment, the metadata gathered is based on the content type of the document. For example, a first content type may require a first set of metadata whereas a second content type may require a second set of metadata to be gathered for the document.

Flowing to operation 330, any pre-rules are applied to the document. A pre-rule may be any action that is performed on the document before it is submitted to the routing engine. For example, a pre-rule may be to convert the document to another format, format the document, add/delete fields, and the like.

Transitioning to operation 340 the document is submitted to the routing engine. The routing engine then accesses the rules that are associated with the document. According to one embodiment, the rules gathered are based on the content type of the document. According to one embodiment, the document is automatically submitted to the routing engine at predetermined times. For example, once a document is placed into the drop off zone and the metadata is gathered a process may periodically access the drop off zone and submit the completed documents to the routing engine.

Moving to operation 350, the routing rules are applied to determine the action to take with the document. According to one embodiment, the routing rules are applied one by one to the document's metadata based on the rule's priority ranking with the highest priority rule being applied first.

Flowing to decision operation 360, a determination is made as to whether the rule matches the metadata that is associated with the document. When the rule does not match, the process returns to operation 350 where the next rule is applied.

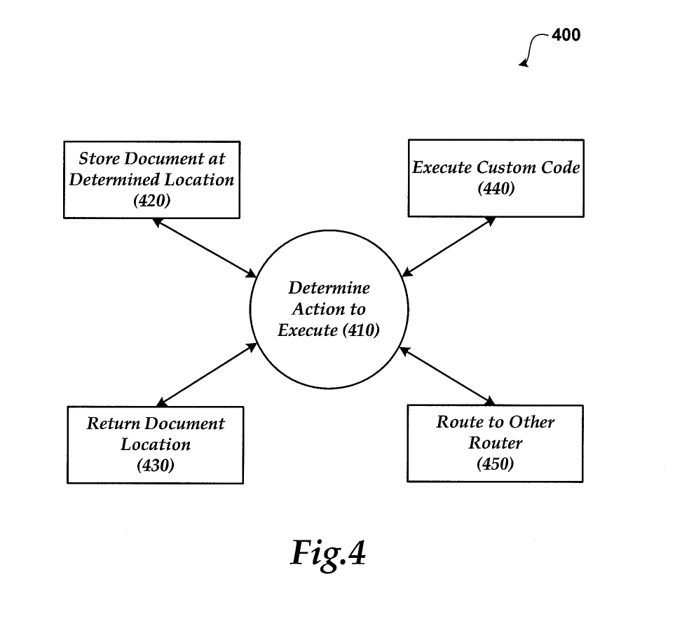

When the rule does match, the operation moves to operation 370 where the rule is executed. Generally, the rule may store the document at a specific location, return a location where the document would be stored, or execute custom code (See FIG. 4 and related discussion).

The process then flows to an end operation and returns to processing other actions.

FIG. 4 illustrates a diagram 400 for executing a rule for document routing using metadata.

At operation 410, a determination is made as to what action is to be executed. According to one embodiment, the action is determined from storing the document at a determined location (420), returning the document location where the document would be stored (430), executing custom code (440), and routing the document to another routing engine (450). Other actions may be configured depending on the application.

When the action is to store the document at a determined location, the process moves to operation 420 where the document is stored at the location determined by the rule. When the document location exists, then the document is saved to the location. According to one embodiment, when the document location does not exist, then the file location is created. This may involve creating one or more directories in a directory structure in order to save the document at the determined location. According to another embodiment, when the document location does not exist a warning may be returned indicating that the document location does not exist and request further action from the user. This action could include creating the document location and/or authorizing the creation of the document location.

When the action is to return the document location, the process moves to operation 430 where the document location is returned to the user that indicates where the document would be located if the routing engine was instructed to store the document. According to one embodiment, the document location is returned as a Uniform Resource Locator (URL) that indicates the location of the document. Other methods of indicating the file location may also be used. For example, a location may be provided as text, a directory in a window could be highlighted to indicate the location of the document, and the like.

When the action is to route the document to another router, the process moves to operation 450 where the document and the associated metadata is routed to another router (450) at which point the router applies its own set of rules to the document.

When the action is to execute custom code, the process moves to operation 440 where the custom code (440) that is indicated by the rule is executed. The custom code could be configured to execute any action(s). For example, the custom code could convert the file to a specific format, store the file at a location, and return a link to the location.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for automatically routing a document using the document's metadata, comprising:
gathering routing rules for the document; wherein the routing rules are prioritized according to an order to which to apply to the document;
determining a matching rule by applying each of the routing rules according to the prioritization against the document's metadata until a match is found; and
executing the matching rule; wherein the matching rule performs one of the following actions: storing the document at a document location specified by the matching rule; returning the document location specified by the matching rule; executing custom code specified by the matching rule and routing the document and the document's metadata to another routing engine.

2. The method of claim 1, further comprising determining when the document is placed in a drop off zone; determining a content type of the document.

3. The method of claim 1, wherein returning the document location specified by the matching rule comprising providing a Uniform Resource Locator (URL) to the document location.

4. The method of claim 1, wherein determining the matching rule comprises determining when a property of the document's metadata matches an attribute within the rule.

5. The method of claim 1, associating a portion of the metadata rules with a level in a document hierarchy such that the portion of rules are applied only to documents at that level within the hierarchy.

6. The method of claim 2, further comprising gathering the document's metadata based on the determined content type further.

7. The method of claim 1, wherein routing the document and the document's metadata to another routing engine comprises routing the document and the document's metadata to a different network location.

8. A computer-readable storage medium having computer-executable instructions for automatically routing a document using the document's metadata, the instructions comprising:
determining a content type for the document;
gathering routing rules for the document based on the content type; wherein the gathered routing rules are a portion of the routing rules associated with a routing engine;
applying the gathered routing rules to the document's metadata according to a prioritized order;
determining when one of the gathered routing rules matches the document's metadata; and
executing the matching rule; wherein the matching rule performs one of the following actions: storing the document at a document location specified by the matching rule; returning the document location specified by the matching rule; executing custom code specified by the matching rule and routing the document and the document's metadata to another routing engine.

9. The computer-readable storage medium of claim 8, further comprising providing a user interface to edit the routing rules and prioritize the routing rules.

10. The computer-readable storage medium of claim 9, further comprising determining when the document is placed in a drop off zone and in response to the document being placed in the drop off zone gathering the document's metadata from user input.

11. The computer-readable storage medium of claim 10, wherein storing the document at the document location comprises creating a directory structure before storing the document at the document location.

12. The computer-readable storage medium of claim 11, wherein returning the document location comprises creating a Uniform Resource Locator (URL) to the document location and returning the URL.

13. The computer-readable storage medium of claim 12, further comprising associating a portion of the routing rules with a level in a hierarchy.

14. The computer-readable storage medium of claim 12, wherein routing the document and the document's metadata to another routing engine comprises routing the document to more than one other routing engine.

15. A system for automatically routing a document using the document's metadata, comprising:
a processor and a computer-readable medium;
an operating environment stored on the computer-readable medium and executing on the processor;
a document repository configured to store documents; and
a routing engine that is configured to:
determine a content type for the document;
gather routing rules for the document based on the content type; wherein the gathered routing rules are a portion of the routing rules associated with a routing engine;
determine when one of the gathered routing rules matches the document's metadata by applying the gathered routing rules in a prioritized order against the document's metadata; and
execute the matching rule; wherein the matching rule performs one of the following actions: storing the document at a document location within the document repository specified by the matching rule; returning the document location specified by the matching rule; executing custom code specified by the matching rule and routing the document and the document's metadata to another routing engine.

16. The system of claim 15, further comprising a display that is configured to display a user interface for editing the routing rules and routing engine properties.

17. The system of claim 15, further comprising a drop off zone that is a central repository for placing documents before they are submitted to the routing engine.

18. The system of claim 15, wherein storing the document at the document location within the document repository comprises creating a directory structure within the document repository before storing the document at the document location.

19. The system of claim 15, wherein returning the document location comprises creating a Uniform Resource Locator (URL) to the document location and supplying the URL.

20. The system of claim 15, wherein routing the document and the document's metadata to another routing engine comprises routing the document and the document's metadata to another network location.
